(19) United States
(12) Patent Application Publication
(10) Pub. No.: US 2008/0155437 A1
(43) Pub. Date: Jun. 26, 2008

(54) Methods, systems, and computer program products for controlling presentation of dynamic content in a presentation element

(76) Inventor: Robert P. Morris, Raleigh, NC (US)

Correspondence Address: SCENERA RESEARCH, LLC;JENKINS, WILSON & TAYLOR, P.A., 3100 TOWER BLVD, SUITE 1400, DURHAM, NC, 27707, US

(21) Appl. No.: 11/643,490

(22) Filed: Dec. 21, 2006

(51) Int. Cl. G06F 3/048; G06F 3/00

(52) U.S. Cl. 715/765; 715/730; 715/764; 715/781

(57) ABSTRACT

Methods, systems, and computer program products for controlling presentation of dynamic content in a presentation element are disclosed. According to one aspect, a method includes detecting presentation of dynamic content in a first presentation element. The presentation of dynamic content is associated with a first application. A change is detected to a second presentation element associated with a second application. The change to the second presentation element is concurrent with the presentation of the dynamic content. Whether a threshold condition has been met is determined using a measure based on a hidden portion of the first presentation element. The presentation of the dynamic content or the first presentation element is controlled based on the threshold determination.

### TECHNICAL FIELD

The subject matter described herein relates to the presentation of content in a presentation element. More particularly, the subject matter described herein relates to methods, systems, and computer program products for controlling presentation of dynamic content in a presentation element.

### BACKGROUND

Electronic devices typically include a display for presenting presentation elements, such as presentation windows, icons, and various other suitable types of displayable objects. Presentation elements are associated with executables known as applications. Different presentation elements provided on a display may be associated with different applications. For example, one presentation window may be associated with a word processing application for presenting text content to a user, and another presentation window may be associated with a media application for presenting video content to a user.

Many electronic devices are configured to concurrently display multiple presentation elements. One problem associated with concurrently displaying multiple presentation elements is that the presentation elements may interfere with one another such that the content of one or more of the presentation elements cannot be satisfactorily perceived by a user. For example, when multiple presentation windows are simultaneously displayed, a portion or all of one of the presentation windows may be hidden from the user because the presentation windows overlap. The hidden portion of the presentation window may have varying degrees of importance to the user.

Dynamic content, such as streaming media, active web pages, applications, and communication sessions, may be included in presentation elements and have an increased importance over other types of content provided in presentation elements. One problem associated with current systems is that dynamic content continues to be presented when its presentation element is partially or completely occluded by another presentation element, regardless of the importance to a user. For example, a streamed video may be of great importance to a user. During the video presentation, an instant messaging (IM) popup may be received that obscures some or all of the video display window. The streamed video continues to play, but the user cannot see the video until active steps are taken to move one of the presentation elements such that there was no overlap, to remove the interfering presentation element, or to otherwise adjust the presentation elements such that the video can be perceived.

Accordingly, in light of the above described difficulties and needs, there exists a need for improved methods, systems, and computer program products for controlling presentation of dynamic content in a presentation element.

### SUMMARY

The subject matter described herein includes methods, systems, and computer program products for controlling presentation of dynamic content in a presentation element are disclosed. According to one aspect, the subject matter described herein includes a method for controlling presentation of dynamic content in a presentation element. The method includes detecting presentation of dynamic content in a first presentation element. The presentation of dynamic content is associated with a first application. A change to a second presentation element associated with a second application is detected. The change to the second presentation element is concurrent with the presentation of the dynamic content in the first presentation element. It is determined, using a measure based on a hidden portion of the first presentation element, whether a threshold condition has been met. At least one of the presentation of the dynamic content and the first presentation element is automatically controlled based on the threshold determination.

According to another aspect, the subject matter described herein includes a system for controlling presentation of dynamic content in a presentation element. The system includes a painter function configured to detect presentation of dynamic content in a first presentation element. The presentation of dynamic content is associated with a first application. The painter function is also configured to detect a change to a second presentation element associated with a second application. The change to the second presentation element is concurrent with the presentation of the dynamic content in the first presentation element. Further, the system includes a presentation element manager configured to determine, using a measure based on a hidden portion of the first presentation element, whether a threshold condition has been met. The presentation element manager is configured to automatically control at least one of the presentation of the dynamic content and the first presentation element based on the threshold determination.

### BRIEF DESCRIPTION OF THE DRAWINGS

Preferred embodiments of the subject matter described herein will now be explained with reference to the accompanying drawings of which:

FIG. 1 is a block diagram of an exemplary system for controlling presentation of dynamic content in a presentation element according to an embodiment of the subject matter described herein; and

FIG. 2 is a flow chart of an exemplary process for controlling presentation of dynamic content in a presentation element according to an embodiment of the subject matter described herein.

### DETAILED DESCRIPTION

The subject matter described herein includes methods, systems, and computer program products for controlling presentation of dynamic content in a presentation element. According to one aspect, a system according to the subject matter described herein may be implemented as hardware, software, and/or firmware components executing on one or more components of a system configured to present content and presentation elements on a graphical user interface.

As used herein, the term “presentation element” refers to any object supported by a graphical user interface system. The term “widget” or “GUI widget” is often used to refer to a presentation element by those skilled in the art. Examples of presentation elements include windows, panes, containers, and input controls. A subset of presentation elements are capable of displaying dynamic content, such as windows and panes of various types. In one example, a presentation element may be a window within a region of a display for presenting graphics and text. In another example, a presentation element may be an in input control such as button for displaying text and/or graphics within a region of a display. Exemplary content within a presentation element includes video, images, text, and any other graphics suitable for display.

As used herein, the term “dynamic content” refers to presentable content that changes without requiring user intervention. Examples of dynamic content include video, a slide show, and animated displays. Other examples of dynamic content include active drawings (e.g., graphs of real-time performance statistics) and presentations including periodic or real-time updates of data (e.g., stock quotes, logs, and chat windows). Dynamic content may be broadcast content, such as a television video broadcast.

As used herein, the term “application” refers to an executable associated with a presentation element. For the purposes of this description, a single application with two or more separate presentation elements is considered to be two or more applications each with an associated presentation element.

As used here, a “computer readable medium” can be any means that can contain, store, communicate, propagate, or transport the computer program for use by or in connection with the instruction execution machine, system, apparatus, or device. The computer readable medium can be, for example, but not limited to, an electronic, magnetic, optical, electromagnetic, infrared, or semiconductor machine, system, apparatus, device, or propagation medium.

More specific examples (a non-exhaustive list) of the computer readable medium can include the following: a wired network connection and associated transmission medium, such as an Ethernet transmission system, a wireless network connection and associated transmission medium, such as an IEEE 802.11(a), (b), or (g) or a Bluetooth™ transmission system, a wide-area network (WAN), a local-area network (LAN), the Internet, an intranet, a portable computer diskette, a random access memory (RAM), a read only memory (ROM), an erasable programmable read only memory (EPROM or Flash memory), an optical fiber, a portable compact disc (CD), a portable digital video disc (DVD), and the like.

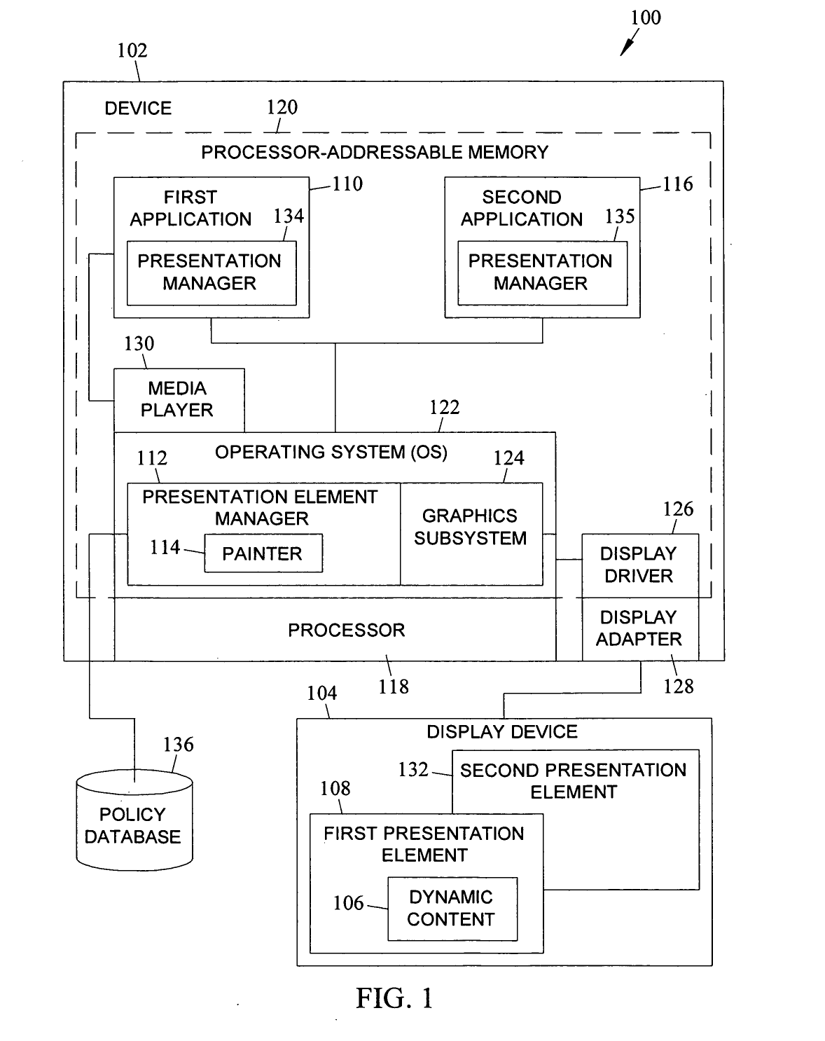

FIG. 1 is a block diagram of an exemplary system 100 for controlling presentation of dynamic content in a presentation element according to an embodiment of the subject matter described herein. Referring to FIG. 1, system 100 includes an electronic device 102 and an associated display device 104. Device 102 may be a computer, mobile phone, smart phone, or any other device configured to run one or more applications, each of which may be an executable associated with a presentation element. Display device 104 may be configured to present presentation elements on its display. Details of exemplary components of devices 102 and 104 will be provided below.

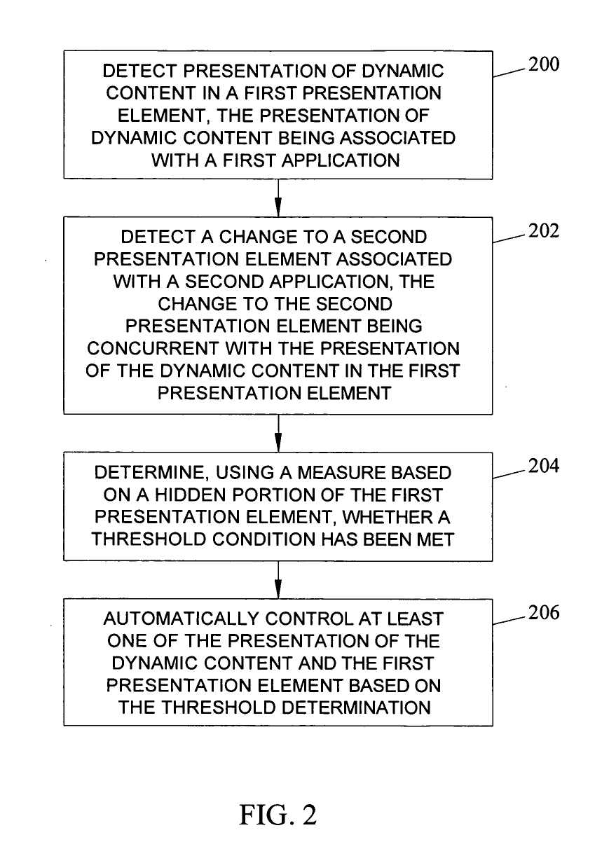

In accordance with the subject matter described herein, system 100 controls the presentation of dynamic content in a presentation element associated with an application based on a detection of a change to another presentation element associated with another application. FIG. 2 is a flow chart illustrating an exemplary process for controlling presentation of dynamic content in a presentation element according to an embodiment of the subject matter described herein. Referring to FIGS. 1 and 2, in block 200 the process provides for detecting presentation of dynamic content 106 in a first presentation element 108. The presentation of dynamic content 106 is associated with a first application 110. System 100 includes means for detecting presentation of dynamic content in a first presentation element, wherein the presentation of dynamic content is associated with an application. For example, as described in more detail herein, a presentation element manager 112 includes a painter function 114 configured to detect presentation of dynamic content 106 in first presentation element 108, wherein the presentation of dynamic content 106 is associated with first application 110.

Device 102 provides an execution environment within which applications may operate. For example, first application 110 and a second application 116 can operate within the execution environment provided by device 102. The execution environment depicted of device 102 includes a processor 118 and a processor-addressable memory 120, which is associated with a virtual address space mapped to processor-accessible physical random access memory (RAM) (not shown) and a swap file stored in a secondary storage (not shown). First application 110 and second application 116 may be supported by an operating system (OS) 122.

In the exemplary system 100, operating system 122 includes presentation element manager 112 for supporting a graphical user interface. Further, operating system 122 includes a graphics subsystem 124 configured to access a plurality of display buffers at the request of presentation element manager 112 for drawing various presentation elements supported by presentation element manager 112. Graphics subsystem 124 communicates with a display driver 126 for controlling a display adapter 128, which is coupled to display device 104 for allowing first application 110 and second application 116 to present content in one or more presentation elements.

As stated above, the presentation of dynamic content 106 is associated with first application 110. For example, first application 110 causes first presentation element 108 including dynamic content 106 to be displayed on the display of display device 104 by communicating with presentation element manager 112, which operates as a part of and is supported by operating system 122. Presentation element manager 112 uses painter function 114 to issue commands to graphics subsystem 124 to write one or more display buffers including overlay buffers for creating a representation of first presentation element 108, including dynamic content 106, in processor addressable memory 120 and/or memory reserved for supporting display presentation.

Graphics subsystem 124 of exemplary system 100 on request by presentation element manager 112, provides at least a portion of a representation of presentation element 108 that is associated with a visible portion of presentation element 108 to display driver 126. In response to receiving the representation, display driver 126 controls display adapter 128 to communicate with display device 104 for presenting (i.e., displaying for visualization by a user) at least a portion of presentation element 108.

Painter function 114 in the embodiment tracks various coordinate spaces that are used for drawing by users of presentation element manager 112 and on behalf of presentation element manager 112. For this purpose, painter function 114 tracks the locations of all presentation elements, including content such as text and graphics, whether they are currently visible by a user on the display of display device 104 or hidden. Painter function 114 may only paint and/or repaint text and graphics that are visible on the display of display device 104. Painting and/or repainting a presentation element when it is at least partially hidden can consume unneeded system resources. In order to support an efficient technique of painting or repainting on display device 104, painter function 114 tracks portions of presentation elements that are visible and hidden.

First application 110 may use a media player 130 for rendering dynamic content 106 in a display region bounded by presentation element 108. Media player 130, in the embodiment, uses presentation element manager 112 and painter function 114 to drive graphics subsystem 124, which causes display driver 126 interoperating with display adapter 128 to dynamically update the region of display within presentation window 108 containing dynamic content 106 from media player 130. In one example, once presentation element manager 112 and painter function 114 have established the display region bounded by presentation manager element 108, media player 130 may be provided with direct access to graphics subsystem 124 enabling more efficient presentation of dynamic content 106 within the bounded display region established.

As described above, paint and repaint operations involve processing by painter function 114. Thus, painter function 114, in the exemplary system 100, is operable to detect display operations involving presentation elements and dynamic content. In particular, painter function 104 detects the presentation of dynamic content in presentation elements and changes to presentation elements. In the example depicted in FIG. 1, painter function 114 detects display operations involving presentation element 108. Further, as described above, in order to support efficient display painting, painter function 114 tracks the location of presentation elements, such as presentation element 108, its size and its z-order (i.e., whether a presentation window or presentation element is behind or in front of another presentation window or presentation element) with respect to other instantiated presentation windows and/or presentation elements.

In block 202, a change to a second presentation element associated with a second application is detected. The change to the second presentation element is concurrent with the presentation of the dynamic content in the first presentation element. System 100 includes means for detecting a change to a second presentation element associated with a second application, wherein the change to the second presentation element is concurrent with the presentation of the dynamic content in the first presentation element. For example, painter function 114 is configured to detect a change to a second presentation element 132 associated with second application 116. In this example, the change to presentation element 132 is concurrent with the presentation of dynamic content 106 in first presentation element 108.

In the example, second application 116 causes second presentation element 132 to be presented on the display of display device 104 by requesting the creation of second presentation element 132 according to parameters and instruction provided by second application 116. Presentation element manager 112 uses painter function 114 to issue one or more commands to graphics subsystem 124 to cause a representation of second presentation element 132 to be written using one or more memory regions within processor-addressable memory 120 and/or buffers allocated for display memory. At the instruction of presentation element manager 112 responding to an event caused by an executable in a component of system 100 (e.g., operating system 122, first application 110, and second application 116), painter function 114 instructs graphics subsystem 124 to update at least a portion of the display of display device 104 by activating one or more regions of the buffers in processor-addressable memory 120 and/or display memory. Graphics subsystem 124 causes the requested update by identifying at least a portion of a buffer to display driver 126 to write to display adapter 128 which causes the request update by communicating with display device 104 across a communications link between display adapter 128 and display device 104.

First presentation element 108 and second presentation element 132 may overlap one another during concurrent presentation on the display of display device 104. For example, second presentation element 132 may be displayed “behind” first presentation element 108 such that an overlapped portion or all of second presentation element 132 is hidden behind first presentation element 108. In another example, second presentation element 132 may be displayed in “front” of first presentation element 108 such that an overlapped portion or all of presentation element 108 is hidden behind second presentation element 132. Further, first presentation element 108 and second presentation element 132 may be presented on the display of display device 104 such that there is no overlap of any portion of first presentation element 108 and second presentation element 132. When there is no overlap, first presentation element 108 and second presentation element 132 may have the same z-order.

Painter function 114, in system 100, is configured to detect first presentation element 108 and track different parameters of first presentation element 108 with respect to second presentation element 132. For example, painter function 114 may be configured to track the position, size, and/or z-order of first presentation element 108 with respect to second presentation element 132. Accordingly, painter function 104 detects a change to a second presentation element associated with a second application, wherein the change to the second presentation element is concurrent with the presentation of dynamic content in the first presentation element.

In block 204, it is determined, using a measure based on a hidden portion of the first presentation element, whether a threshold condition has been met. The threshold condition may be met when the measure exceeds a threshold or is lower than a threshold depending on the implementation of the system. A measure may, for example, be based on at least one of a size of a hidden portion of the first presentation element, a priority of a hidden portion of the first presentation element, and a duration that a portion of the first presentation element is hidden. System 100 includes means for determining, using a measure based on a hidden portion of the first presentation element, whether a threshold condition has been met. In one embodiment, painter function 114 is configured to determine using a measure based on a hidden portion of first presentation element 108, whether a threshold condition has been met. In another embodiment, using a measure based on a size of a hidden portion of first presentation element 108, a priority of a hidden portion of first presentation element 108, and/or a duration that a portion of first presentation element 108 is hidden, presentation element manager 112 determines whether a threshold condition has been met.

On each paint or repaint operation, painter function 114 may determine and update regions of display device 104 that have changed. A determination of a change of display 104 may include tracking whether a presentation element has a different position, size, and/or z-order, for example. Painter function 114, in one embodiment, is enabled to detect when a presentation element loses focus or receives input.

In the embodiment, painter function 114, using tracked information associated with first presentation element 108, detects when a portion of first presentation element 108 becomes hidden. For example, second presentation element 132 may be displayed over a portion of first presentation element 108 as directed by presentation element manager 112 and painter function 114, causing its z-order to change such that a portion of first presentation element 108 becomes hidden. Painter function 114 tracking the position, size, and z-order of presentation elements uses the tracked information to determine whether one or more portions of first presentation element 108 are hidden. Presentation element manager 112 using tracked information from painter function 114 is able to determine, for example, a size of the hidden portion of the first presentation element, a priority of the hidden portion of the first presentation element based on information provided by first application 110 and second application 116, and a duration that the portion of first presentation element 108 is hidden. Based on information associated with the hidden portion of the first presentation element, presentation element manager 112 determines a measure. Presentation element manager 112 may be provided with information for calculating a ratio and/or an absolute measure associated with a hidden and/or visible portion of first presentation element 108. For example, a ratio of the size of hidden portions of first presentation element 108 to visible portions of first presentation element 108 may be calculated. In another example, a portion of first presentation element 108 may be assigned a value associated with its priority with respect to dynamic content being presented in first presentation element 108. The priority may be provided by an application, may be a configured value, or may be determined using dynamic information such as input received associated with a presentation element for determining an activity level and calculating a priority based on the activity level. A plurality of portions of a presentation element can be assigned priorities and a relative and/or absolute measure can be derived based on the hidden portions and their respective priorities. When the displayed content is dynamic content, the priorities associated with the displayed portions may change. In another example, presentation element manager 112 may determine whether first presentation element 108 has gained or lost focus for use in determining whether a threshold condition based on a measure has been met. For example, if device 102 supports gaze tracking, presentation element manager 112 may be provided with information as to whether a presentation element is being viewed or regarding a detected pattern of viewing of the presentation element by a user.

In one example, presentation element manager 112 may be configured to calculate a ratio based on the size of hidden portions of first presentation element 108 to the size of visible portions. Further, in this example, presentation element manager 112 may compare the value of the ratio to a threshold to determine whether the ratio exceeds the threshold meeting the threshold condition. The inverse of the ratio may be used for causing the determination step to detect whether the ratio is lower than the threshold meeting the threshold condition.

Regardless of the measure based on a hidden portion of the first presentation element 108 used in the embodiment, presentation element manager 112 determines whether a threshold condition has been met.

In another embodiment, as described above, on each paint or repaint operation, painter function 114 may determine and update regions of the display of display device 104 that have changed. A determination of a change of the display may include tracking whether a presentation element has a different position, size, and/or z-order. Applications associated with presentation elements are configured to receive a notification when a presentation element has been painted or repainted and/or when a presentation element's size, position, and/or z-order has changed. Further, an application may be enabled to be notified when a presentation element loses focus or receives input. For example, presentation manager 134 of first application 110 may receive notification of a change of the display of display device 104 by tracking whether first presentation element 108 has a different position, size, and/or z-order.

In one example, presentation manager 134 of first application 110 may be configured to receive notifications related to events where at least a portion of first presentation element 108 becomes hidden. For example, second presentation element 132 may be displayed over a portion of first presentation element 108 causing its z-order to change such that the portion becomes hidden. Presentation manager 134 of first application 110 may receive information for use in determining whether one or more portions of first presentation element 108 are hidden. Presentation manager 134 of first application 110 may be configured to determine the location, size, and/or z-order of each portion. Further, presentation manager 134 of first application 110 can be provided with information for calculating a ratio and/or an absolute measure associated with a hidden and/or visible portion of first presentation element 108. For example, a ratio of the size of hidden portions of presentation element 108 to visible portions of the presentation window may be calculated. In another example, a portion of presentation element 108 may be assigned a value associated with its priority with respect to dynamic content being presented in presentation element 108. In this example, the priority value may be used for determining when a portion is hidden and for comparing its priority to a predetermined threshold. A plurality of portions of a presentation element can be assigned priorities and a relative and/or absolute measure can be derived based on the hidden portions and their respective priorities. When the displayed content is dynamic content, the priories associated with the displayed portions may change. In another example, presentation manager 134 of first application 110 may determine whether presentation element 108 has gained or lost focus for use in determining whether a threshold condition has been met. For example, if device 102 supports gaze tracking, an application may be provided with information as to whether a presentation element is being viewed or a pattern of viewing of the application window by a user.

Presentation manager 134 of first application 110 is configured to receive information from painter function 114 via presentation element manager 112 when a presentation related event occurs that affects the visibility of at least a portion of first presentation element 108. In a system supporting gaze tracking, presentation manager 134 of first application 110 may be configured to receive information from a gaze subsystem when a portion of a presentation element, such as first presentation element 108, is being viewed or not viewed. In one example, presentation manager 134 of first application 110 may be configured to calculate a ratio based on the size of hidden portions of first presentation element 108 to the size of visible portions. Further, in this example, presentation manager 134 may compare the value of the ratio to a threshold to determine whether the ratio exceeds the threshold, thus meeting the threshold condition. The inverse of the ratio may be used for causing the determination step to detect whether the ratio is lower than a threshold.

In another example, presentation element manager 112 may receive an indication that a mouse click has been received in second presentation element 132. In response to receiving the indication, presentation element manager 112 may designate second presentation element 132 as having focus and therefore change the z-order of second presentation element 132 to cause it to be displayed at a top level such that it is completely visible. Further, presentation element manager 112 notifies second application 116 of the focus event. Presentation element manager 112 may also change the z-order of first presentation element 108 when it is determined that two presentation elements overlap and second presentation element 132 is presented over first presentation element 108. Presentation element manager 112 can invoke painter function 114 to respond to the changes. As a result, second application 116 may receive a paint event from painter function 114.

Second application 116 can provide painter function 114 with information allowing painter function 114 to determine the content that should be presented. Painter function 114 may determine the regions of second presentation element 132 that need to be updated on the display of display device 104. The regions to be updated include the portion of second presentation element 132 that is hidden due to the presentation of first presentation element 108. Painter function 114 has data representing the area of overlap and is therefore able to drive the presentation system to cause the hidden portion of second presentation element 132 to be made visible on the display of display device 104, thus causing the associated region of first presentation element 108 to be hidden.

Presentation manager 134 of first application 110 and a presentation manager 135 of second application 116 can be configured to receive information from presentation element manager 112 and painter function 114 for allowing each application to track the size and visibility of the area of overlap. For example, presentation manager 134 of first application 110 may calculate the size of the overlap area which is hidden and the size of the remaining viewable portion of first presentation element 108. Presentation manager 134 of first application 110 may calculate a ratio based on the two sizes and compare the ratio to a threshold. When the ratio exceeds the threshold, presentation manager 134 of first application 110 may respond to control at least one of presentation of dynamic content 106 and first presentation element 108 as described in more detail herein. Alternatively, when the ratio is less than the threshold, presentation manager 134 of first application 110 may respond to control at least one of presentation of dynamic content 106 and first presentation element 108 as described in more detail herein. In another example, presentation manager 135 of second application 116 may use a priority associated with the hidden overlap area and determine whether the priority exceeds a predetermined value. In this example, presentation manager 135 of second application 116 may notify presentation manager 134 of first application 110 that the priority exceeds a predetermined value. In response, presentation manager 134 of first application 110 may respond to control at least one of presentation of dynamic content 106 and first presentation element 108 as described in more detail herein.

In one example, presentation manager 134 of first application 110 may respond when multiple portions of first presentation element 108 are hidden by more than one presentation element associated with other applications. Presentation manager 134 of first application 110 may determine the total size of the hidden portions and the total size of the remaining visible areas of first presentation element 108. Further, presentation manager 134 of first application 110 may determine, dynamically or via configuration information, which portions of first presentation element 108 have a high priority. This information may be used for determining whether a threshold condition has been met based on the priority of the hidden portions, either in absolute or relative terms. Further, presentation manager 134 of first application 110 may determine whether the viewed time of first presentation window 108 exceeds either an absolute threshold or a relative threshold compared to the viewed time. Further, presentation manager 134 of first application 110 may determine whether first presentation element 108 has lost focus and may use this determination as another basis for determining whether a threshold condition has been met.

Accordingly, presentation manager 134 of first application 110 may determine a measure based on the size of hidden portions of presentation element 108, a measure based on the priority of the hidden portions of presentation element 108, and a measure based on a duration that presentation element 108 is hidden, for example. These measures may be used alone or in combination for determining whether a threshold condition has been met. These measures may also be used in combination with a focus state of presentation element 108 for determining whether a threshold condition has been met. The list of measures is not meant to be exhaustive.

In an embodiment described earlier, presentation element manager 112 interoperating with painter function 114 may perform operations analogous to those described above by presentation managers 134 135 and applications 110 and 116. That is, presentation element manager 112 may determine a measure based on the size of hidden portions of presentation element 108, a measure based on the priority of the hidden portions of presentation element 108, and a measure based on a duration that presentation element 108 is hidden, for example. These measures may be used alone or in combination for determining whether a threshold condition has been met. These measures may also be used in combination with a focus state of presentation element 108 for determining whether a threshold condition has been met. The list of measures is not meant to be exhaustive.

Thresholds may be determined based on one or more policies associated with an application or maintained by the system. Policies may be hard-coded, retrievable, or associated with dynamic content presented in a presentation element associated with the application. For example, a policy may be associated with dynamic content 106 associated with first presentation element 108. In the case of the policy being associated with dynamic content, the dynamic content may be associated with policy information determining the data that is gathered and calculated, and the thresholds or conditions that are associated with a response from the application.

In one embodiment, the presentation element manager 112 may be configured to determine measures, whether absolute or relative, and determine focus information on behalf of a presentation manager of an application that requests the measures associated with a presentation element. Further, the presentation element manager 112 may be configured to receive policy information specifying conditions and/or thresholds that trigger a response. Thus, in this embodiment, presentation element manager 112 can measure and test conditions, and therefore take actions according to a configured policy and call an application only when needed. In one example, policy information is accessed by presentation element manager 112 from a policy database 136. Policy database 136 may store system default policies, policies based on media type, and may be enable to store application-specific, presentation element-specific, and media-specific policy information. For example, when a threshold condition is met, presentation element manager 112, in the embodiment, sends a message notifying first application 110 of the threshold condition allowing first application 110 to respond by controlling presentation of dynamic content 106 and/or first presentation element 108 as described in more detail herein. Presentation element manager 112 may alternately send a command to first application 110 directing first application to control at least one of presentation of dynamic content 106 and first presentation element 108 in a manner specific to the command. In yet another alternative, painter function 114 may respond to control at least one of presentation of dynamic content 106 and first presentation element 108 directly, for example, by minimizing first presentation element 108 and sending a message to first application 110 indicating the minimizing action allowing first application to further respond, for example, by pausing the dynamic content 106.

In another embodiment, a presentation manager may request a media player component for use in presenting dynamic content in a presentation element. For example, presentation manager 134 of first application 110 may request a media player 130 play dynamic content 106 in first presentation element 108. Media player 130 may be configured to receive information from painter function 114 via presentation element manager 112 and, based on policy information, calculate a specified measure, test a specified threshold condition, and take an action and/or invoke first application 110 or presentation manager 134 included in first application 110 to respond. In one example, media player 130 may be integrated into presentation element manager 112, which may provide routines and APIs enabling applications to present various media types using a common set of code provided by the system.

In block 206, at least one of the presentation of the dynamic content and the first presentation element may be automatically controlled based on the threshold determination. System 100 includes means for automatically controlling one of presentation of dynamic content and a first presentation element based on a threshold determination. For example, presentation manager 134 of first application 110 is configured to automatically control one of presentation of dynamic content 106 and first presentation element 108 based on a threshold determination. In another example, presentation element manager 112 is configured to automatically control one of presentation of dynamic content 106 and first presentation element 108 based on a threshold determination.

Examples of automatically controlling the presentation of dynamic presentation content include pausing the update of the dynamic content, caching streamed content, minimizing the presentation content based on the threshold determination, and maximizing the presentation content based on the threshold determination. In another example, the presentation element including the dynamic presentation content may be moved to a position on a display such that the threshold condition is no longer met at the position. In another example, the presentation element may be automatically closed, restored, or reopened.

In another example of automatically controlling the presentation of dynamic presentation content, an attribute of the presentation content may be changed. Examples of changing an attribute of presentation content include changing a dimension of a presentation element, a location of a presentation element, a rate of change of dynamic content in a presentation element (such as slowing down a video stream), a color of a presentation element, a font associated with a presentation element, a z-order of a presentation element, a focus of a presentation element, a transparency level of a presentation element, and a resolution of a presentation element.

In an example of streamed dynamic content, the content may be automatically cached based on a threshold determination. Presentation of the cached content may resume by based on another detected change to a presentation element.

In the above examples, the presentation manager is described as residing within an application. In one embodiment, a presentation manager may be included within any component of device 102 or its functionality distributed among components of device 102.

In one example of automatically controlling the presentation, a portion or all of the dynamic content may be changed to another format. Further, the dynamic content may be presented in the new format.

In one embodiment, device 102 may receive input for configuring a measure and/or threshold. The type or value of the threshold may be configured. Based on the input, presentation manager may configure the measure and/or threshold.

In another embodiment, when a threshold condition is no longer met, presentation of the dynamic content may be restored. For example, presentation element manager 112 and/or presentation manager 134 may determine that a threshold condition is no longer met. Based on the determination, presentation manager 134 may restore presentation of dynamic content. Alternatively, a user may enter input for explicitly restoring the dynamic content.

In another embodiment, the automatic control of dynamic content or a presentation element may be configurable and/or scriptable. Further, the controlling may be implemented by a plugin associated with at least one of the associated application and the content type.

The subject matter described herein may be implemented using a computer readable medium containing a computer program, executable by a machine, such as a computer. Exemplary computer readable media suitable for implementing the subject matter described herein include chip memory devices, disk memory devices, programmable logic devices, application specific integrated circuits, and downloadable electrical signals. In addition, a computer-readable medium that implements the subject matter described herein may be located on a single device or computing platform or may be distributed across multiple devices or computing platforms.

The executable instructions of a computer program for carrying out the methods illustrated in FIG. 2 can be embodied in any machine or computer readable medium for use by or in connection with an instruction execution machine, system, apparatus, or device, such as a computer-based or processor-containing machine, system, apparatus, or device, that can read or fetch the instructions from the machine or computer readable medium and execute the instructions.

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for controlling presentation of dynamic content in a presentation element, the method comprising:
detecting presentation of dynamic content in a first presentation element, the presentation of dynamic content being associated with a first application;
detecting a change to a second presentation element associated with a second application, the change to the second presentation element being concurrent with the presentation of the dynamic content in the first presentation element;
determining, using a measure based on a hidden portion of the first presentation element, whether a threshold condition has been met; and
automatically controlling at least one of the presentation of the dynamic content and the first presentation element based on the threshold determination.

2. The method of claim 1 wherein detecting presentation of dynamic content in a first presentation element includes detecting a presentation of streamed content in the first presentation element.

3. The method of claim 2 wherein automatically controlling at least one of the presentation of the dynamic content and the first presentation element includes caching the streamed content based on the threshold determination.

4. The method of claim 3 comprising presenting the cached streamed content based on another detected change to the second presentation element.

5. The method of claim 1 wherein determining whether a threshold condition has been met includes using a measure based on a loss of focus within the first presentation element.

6. The method of claim 1 wherein determining, using a measure based on a hidden portion of the first presentation element, whether a threshold condition has been met includes using a measure based on at least one of a size of a hidden portion of the first presentation element, a priority of a hidden portion of the first presentation element, and a duration that a portion of the first presentation element is hidden.

7. The method of claim 1 wherein automatically controlling at least one of the presentation of the dynamic content and the first presentation element includes converting at least a portion of the dynamic content to a second format and presenting the at least a portion of the dynamic content in the second format based on the threshold determination.

8. The method of claim 1 wherein automatically controlling at least one of the presentation of the dynamic content and the first presentation element includes changing an attribute of the first presentation element based on the threshold determination.

9. The method of claim 8 wherein changing an attribute of the first presentation element includes changing at least one of a dimension of the first presentation element, a location of the first presentation element, a rate of change of the dynamic content in the first presentation element, a color of the first presentation element, a font associated with the first presentation element, a z-order of the first presentation element, a focus of the first presentation element, a transparency level of the first presentation element, and a resolution of the first presentation element.

10. The method of claim 1 wherein automatically controlling at least one of the presentation of the dynamic content and the first presentation element includes minimizing the first presentation element based on the threshold determination.

11. The method of claim 1 wherein automatically controlling at least one of the presentation of the dynamic content and the first presentation element includes maximizing the first presentation element based on the threshold determination.

12. The method of claim 1 comprising:
receiving input for configuring one of the measure and the threshold; and
configuring the one of the measure and the threshold based on the received input.

13. The method of claim 1 comprising:
determining that the threshold condition is no longer met; and
in response to determining that the threshold condition is no longer met, restoring presentation of the dynamic content in the first presentation element.

14. The method of claim 1 comprising:
receiving input for restoring the presentation of the dynamic content; and
restoring presentation of the dynamic content in the first presentation element based on the received input.

15. The method of claim 1 comprising configuring the threshold based on a policy associated with the first application.

16. A system for controlling presentation of dynamic content in a presentation element, the system comprising:
a painter function configured to:
detect presentation of dynamic content in a first presentation element, the presentation of dynamic content being associated with a first application;
detect a change to a second presentation element associated with a second application, the change to the second presentation element being concurrent with the presentation of the dynamic content in the first presentation element; and
a presentation element manager configured to:
determine, using a measure based on a hidden portion of the first presentation element, whether a threshold condition has been met; and
automatically control at least one of the presentation of the dynamic content and the first presentation element based on the threshold determination.

17. The system of claim 16 further comprising a presentation manager configured to:
receive information associated with the determination; and
automatically control at least one of the presentation of the dynamic content and the first presentation element based on the threshold determination.

18. The system of claim 17 wherein the presentation manager is configured to detect a presentation of streamed content in the first presentation element.

19. The system of claim 18 wherein the presentation manager is configured to cache the streamed content based on the threshold determination.

20. The system of claim 18 wherein the presentation manager is configured to control presentation of the cached streamed content based on another detected change to the second presentation element.

21. The system of claim 17 wherein the presentation manager is configured to convert at least a portion of the dynamic content to a second format and present the at least a portion of the dynamic content in the second format based on the threshold determination.

22. The system of claim 16 wherein the presentation element manager is configured to determine whether the threshold condition has been met by using a measure based on at least one of a size of a hidden portion of the first presentation element, a priority of a hidden portion of the first presentation element, and a duration that a portion of the first presentation element is hidden.

23. The system of claim 16 wherein the presentation element manager is configured to use a measure based on a loss of focus within the first presentation element for determining whether the threshold condition has been met.

24. The system of claim 16 wherein the presentation element manager is configured to change an attribute of the first presentation element based on the threshold determination.

25. The system of claim 24 wherein the presentation element manager is configured to change one of a dimension of the first presentation element, a location of the first presentation element, a rate of change of the dynamic content in the first presentation element, a color of the first presentation element, a font associated with the first presentation element, a z-order of the first presentation element, a focus of the first presentation element, a transparency level of the first presentation element, and a resolution of the first presentation element.

26. The system of claim 16 wherein the presentation element manager is configured to minimize the first presentation element based on the threshold determination.

27. The system of claim 16 wherein the presentation element manager is configured to maximize the first presentation element based on the threshold determination.

28. The system of claim 16 wherein the presentation element manager is configured to receive input for configuring one of the measure and the threshold and configured to configure the one of the measure and the threshold based on the received input.

29. The system of claim 16 wherein the presentation element manager is configured to determine that the threshold condition is no longer met and configured to restore presentation of the dynamic content in the first presentation element in response to determining that the threshold condition is no longer met.

30. The system of claim 16 wherein the presentation element manager is configured to receive input for restoring the presentation of the dynamic content and configured to restore presentation of the dynamic content in the first presentation element based on the received input.

31. The system of claim 16 wherein the presentation element manager is configured to configure the threshold based on a policy associated with the first application.

32. A system for controlling presentation of dynamic content in a presentation element, the system comprising:
means for detecting presentation of dynamic content in a first presentation element, the presentation of dynamic content being associated with a first application;
means for detecting a change to a second presentation element associated with a second application, the change to the second presentation element being concurrent with the presentation of the dynamic content in the first presentation element;
means for determining, using a measure based on a hidden portion of the first presentation element, whether a threshold condition has been met; and
means for automatically controlling at least one of the presentation of the dynamic content and the first presentation element based on the threshold determination.

33. A computer readable medium containing a computer program, executable by a machine, for controlling presentation of dynamic content in a presentation element, the computer program comprising executable instructions for:
detecting presentation of dynamic content in a first presentation element, the presentation of dynamic content being associated with a first application;
detecting a change to a second presentation element associated with a second application, the change to the second presentation element being concurrent with the presentation of the dynamic content in the first presentation element;
determining, using a measure based on a hidden portion of the first presentation element, whether a threshold condition has been met; and
automatically controlling at least one of the presentation of the dynamic content and the first presentation element based on the threshold determination.
